(19) United States
(12) Patent Application Publication
(10) Pub. No.: US 2011/0035680 A1
(43) Pub. Date: Feb. 10, 2011

(54) METHOD OF SCORING THE PERFORMANCE OF ATTENDEES AT A MEETING

(75) Inventors: Richard D. Borovoy, Boston, MA (US); Timothy M. Gorton, Boston, MA (US)

Correspondence Address: FISH & RICHARDSON P.C. (SV), PO BOX 1022, MINNEAPOLIS, MN, 55440-1022, US

(73) Assignee: nTAG Interactive Corporation, a Delaware corporation

(21) Appl. No.: 12/909,897

(22) Filed: Oct. 22, 2010

Related U.S. Application Data
(63) Continuation of application No. 11/069,716, filed on Feb. 28, 2005.

(51) Int. Cl. G06F 3/01; G06F 15/16

(52) U.S. Cl. 715/751

(57) ABSTRACT

A method of scoring the performance of attendees at a meeting based upon a predetermined desired performance criteria set by a meeting organizer or sponsor. All attendees at the meeting wear electronic tags where goals for the tag-wearer's meeting performance, such as session attendance, survey completion, conversing with certain people, etc., are stored. Each goal has an associated score, and the scores also are retained in the tag. From these goals and scores, a total score is computed from the plurality of scores, the total score being indicative of the overall performance of the attendee at the meeting measured against the predetermined desired performance criteria.

### RELATED APPLICATION

This application is a continuation (and claims the benefit of priority under 35 USC 120) of U.S. application Ser. No. 11/069,716, filed Feb. 28, 2005, the contents of which are incorporated herein in their entirety by reference.

### BACKGROUND OF THE INVENTION

This invention relates to a performance scoring system to provide feedback on an attendee's performance at a meeting or convention.

Several years ago, nTAG Interactive Corporation developed an interactive tag to be worn around the neck of attendees at a convention. This tag has the ability to electronically communicate with other attendees wearing tags when the attendees face each other in conversation. The tags typically exchange data electronically before the attendees even have a chance to talk to each other, providing information to each of the two attendees about what they have in common. The tags also have the capability of communicating wirelessly with readers, such as RFID readers or WiFi or WiMax transceivers. These tags are described in U.S. patent application Ser. No. 10/396,064, filed Mar. 24, 2003, entitled Apparatus and Method for Enhancing Face-to-Face Communication, which is hereby incorporated herein by reference.

### SUMMARY OF THE INVENTION

Recently a new method of using the tags was discovered whereby the tags automatically score an attendee's performance at the meeting or convention based upon pre-established criteria, typically set by the meeting organizer or sponsor. This scoring system was found to provide a powerful incentive to attendees to behave in ways considered desirable by the organizer or sponsor, particularly when prizes were awarded to high scorers.

Briefly, the method of scoring the performance of an attendee at a meeting of this invention is based upon a predetermined desired performance criteria set by a meeting organizer or sponsor. The attendees at the meeting wear computing devices, called “tags” of the type described in the above-referenced Patent Application, that can communicate with other tags worn by others as well as with a central server or computer system.

The method of the invention uses the following steps:

1) recording on a wearable computing device worn by an attendee at a meeting a plurality of indicia of performance of the attendee at the meeting;

2) assigning a score to each of the indicia based upon predetermined performance criteria, thereby obtaining a plurality of scores; and

3) computing a total score from the plurality of scores, the total score being indicative of the performance of the attendee at the meeting measured against the predetermined performance criteria.

### BRIEF DESCRIPTION OF THE DRAWINGS

FIG. 1 is a picture of a tag displaying to the wearer possible points that he or she may obtain by certain actions at the event;

FIG. 2 is another picture of a tag indicating that the person to whom the tag wearer is talking has an associated point value established for talking to him;

FIG. 3 is a picture of a tag showing the wearer's cumulative points obtained at the time as measured against total possible points that may be obtained by the wearer;

FIG. 4 is a flow chart showing how event triggers are used to measure meeting performance goals of attendees;

FIG. 5 is a screen showing a tabulation of goal points achieved by the top 10 point winners at the event;

FIGS. 6, 6A, and 6B are a screen showing a tabulation of goal points achieved by the top 10 point winners at the event for each of three categories of attendee (Executive, Vendor, and Staff);

FIG. 7 is a screen available to a meeting organizer providing survey information regarding a speaker at a particular session of the meeting;

FIG. 8 is a screen available to the meeting organizer showing ratings of speakers provided by various attendees at a session where the speaker made a presentation, broken down by category of attendee; and

FIG. 9 is a table screen used by the event organizer or sponsor to set the various goals of the meeting.

### DETAILED DESCRIPTION OF THE INVENTION

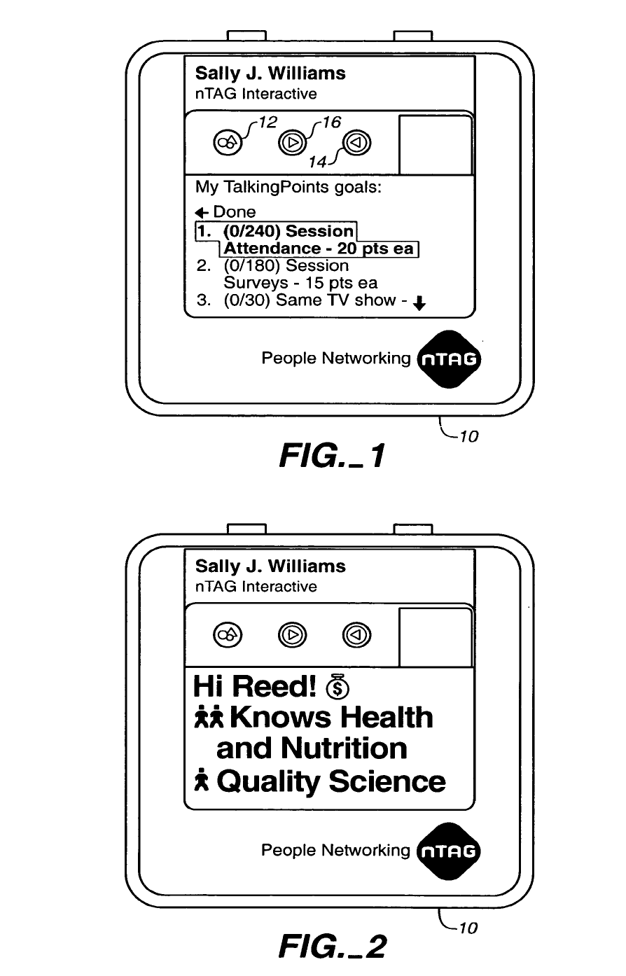

Referring to FIG. 1, the scoring method of the invention uses tag 10 described in the above-referenced Patent Application as one of the sources of data used to compute a tag wearer's score based on events that take place at the meeting. Such events can include, for example, meeting certain people, attending certain sessions, completing certain surveys, or scoring above a given level on quizzes. Some organizers like to give quizzes after a session to see how well the attendees were paying attention.

Returning to the example of FIG. 1, the tag wearer's name is printed at the top of the tag as “Sally J. Williams.” The company name below Sally's name, “nTAG Interactive,” is the assignee of this invention.

As fully described in the above-referenced Patent Application, the tags used in this invention have two reading modes: one is where the tag is being read by someone talking to the tag wearer; and the other is where the tag is read by the tag wearer herself. The mode shown in FIG. 1 is the latter. Note that Item 1 on the tag is highlighted, and says: “(0/240) Session Attendance—20 pts ea.” What this tells the wearer, Sally, is that she can obtain a maximum of 240 points by attending certain sessions at the meeting she is attending, and that, so far, she has attended no sessions and obtained 0 points (“0/240”). This line on the tag also tells Sally that there are 12 possible sessions she can attend, and that each is worth 20 points, for a maximum total of 240 points.

Line 2 shows that Sally can obtain points by filling out a survey, most likely before, during, or after a session. For each survey completed, line 2 shows that she can earn 15 points. Since there are 12 sessions at the meeting, each one has a survey, so she can earn 180 points if she fills out all 12. These surveys are usually completed on the tag itself. When Sally enters a session room, her tag communicates with a short range wireless transceiver, such as an RFID reader. This transceiver can send information to her tag, as well as pass information on her tag back to a central server. When Sally passes the RFID reader in the session room, since the reader knows that Sally is attending the particular session offered at the time Sally enters the room, the server can automatically download to Sally's tag the correct survey associated with the session being conducted at that approximate time in that room. Sally then completes the survey on her tag, preferably by using the three buttons 12, 14, and 16 on her tag in response to multiple choice answers to survey questions. Buttons 12 and 14 are scroll up and down buttons, respectively, and button 16 is a “select” button. She can scroll through the possible answers to each survey question using up and down buttons 12 and 14 until her chosen answer is highlighted on LCD screen 18, and then she hits the select button 16. When she is finished, her survey response is sent from her tag to the central server, typically by the same RFID reader in the session room where Sally is attending.

Line 2 of Sally's tag shows that she has completed no surveys at this time, which stands to reason since line 1 indicated that she had attended no sessions. Line 3 of Sally's tag shows that she can earn 30 points by finding people at the meeting who like the same TV show as Sally. When Sally entered her personal data in advance of the meeting, either through the Worldwide Web or on a computer at the meeting site, all as described in the above-referenced Patent Application, she indicated her favorite TV show was “Sex and the City.” Therefore, for each person she talks to at the meeting who also indicated that Sex and the City was his or her favorite TV show, Sally can earn points. Line 3 shows she has not matched TV shows with anyone yet, but by doing so, she can earn a maximum of 30 points. (This could be, for example, 5, 10, or 15 points for each person she matches with, as determined in advance by the meeting organizer and programmed into the tags.)

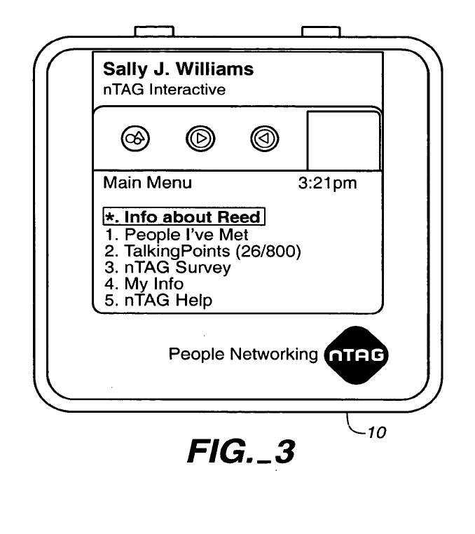

Referring to FIG. 2, tag 10 is in the mode where it is being read by a person, Reed, to whom its wearer, Sally, is talking. As described in the above-referenced Patent Application, when the tag is in this mode, the print is larger so it can be read by Reed, who is looking at Sally's tag hanging around Sally's neck. When viewing Sally's tag, Reed sees a dollar sign and bag icon next to his name. His name appears on Sally's tag because the tags have communicated and each tag knows the identity of the other person. This identity has been sent across the two tags using infrared communication. That line on Sally's tag tells Reed that talking to Sally is earning him points. The fact that Reed talked to Sally is recorded in Reed's tag (and also the fact that Sally talked to Reed is recorded in Sally's tag).

The lines below on Sally's tag indicate what type of knowledge Sally and Reed have. Since there are two “people” icons next to “Knows Health and Nutrition,” both Sally and Reed have this specified type of knowledge. The single person icon next to “Quality Science” indicates that only Sally has this knowledge, not Reed.

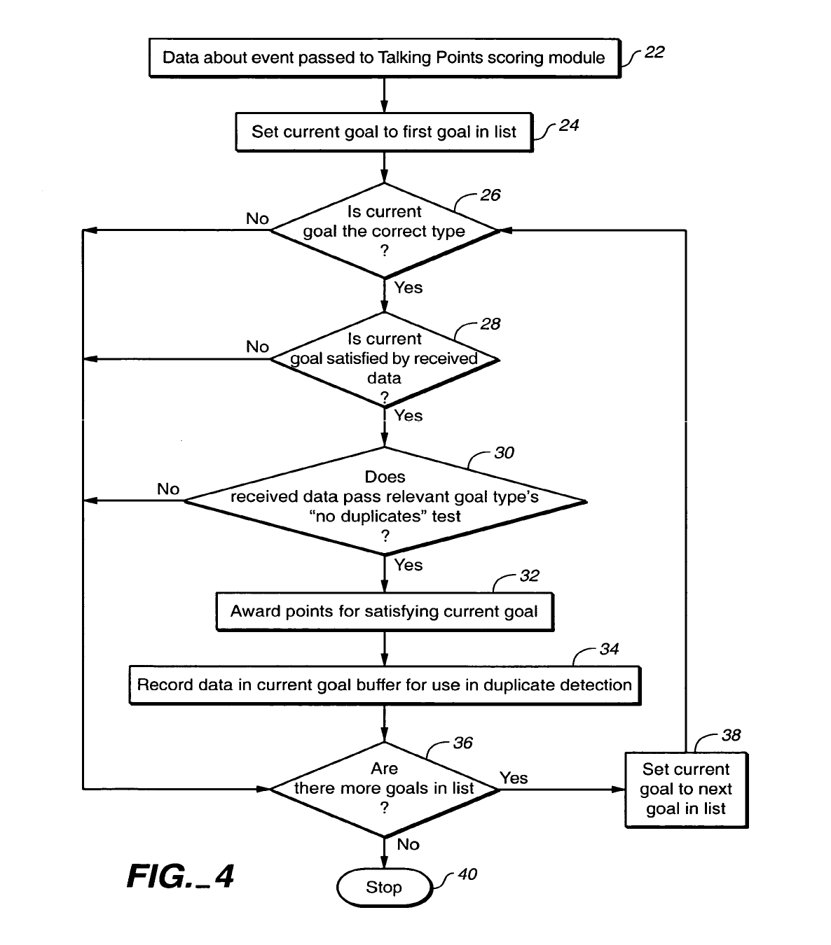

Referring to FIG. 3, a menu is shown on tag 10. This screen is in the mode where it is to be viewed by its own wearer, Sally. If she clicks on the first line shown, she can obtain information about Reed, a person with whom she had conversed earlier. If she clicks on the next line numbered “1,” she can obtain a listing of all the people she talked to. Line 2 shows her that she can obtain a total of 800 points by doing prescribed actions at this meeting (including, inter alia, actions such as talking to certain people, attending sessions, filling out surveys, etc.), and at the time she is reading her own tag, she has accumulated a total of 26 points. By clicking on line 3, Sally can fill out a survey on the nTAG system. It is possible that points may be assigned by the event manager for filling out that survey. Selecting line 4 enables Sally to check out her own data that she furnished in advance of the meeting. Finally, line 5 is a conventional “help screen.”

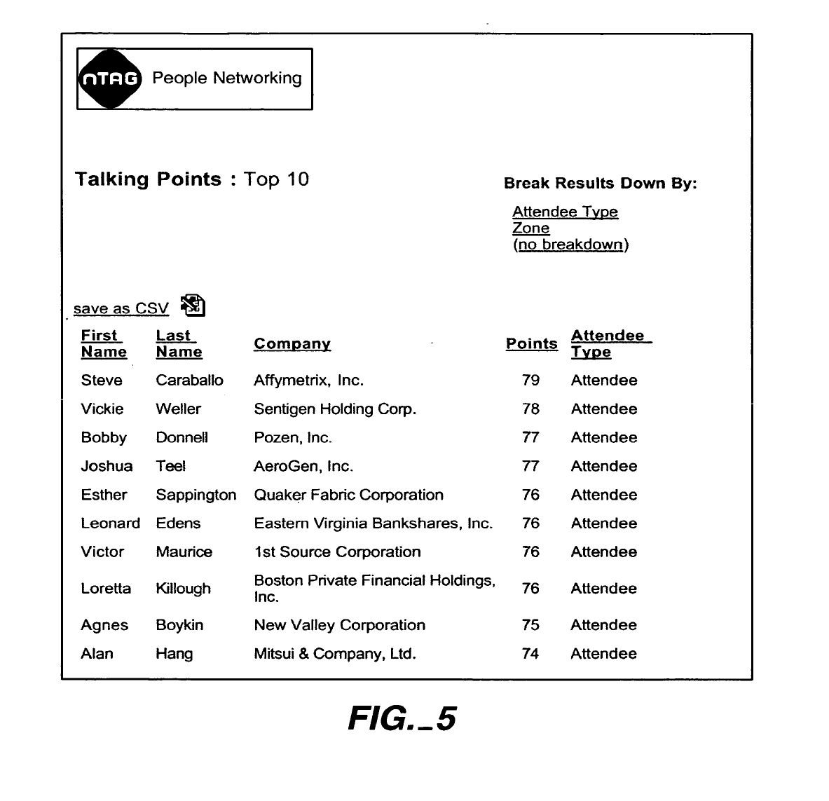

FIG. 4 is a flow chart showing the method of the invention used to track events on a tag. The actual code used to implement the method described in the flow chart of FIG. 4 is appended to this application as Appendix A. At step 20, an event that happens to a tag wearer triggers a scoring update. For example, the event may be where the tag wearer meets another person, attends a session, or completes a survey. For purposes of illustration, assume a first tag wearer meets a second tag wearer. The first tag wearer's tag communicates, for example, using infrared transmission, with the second tag wearer's tag. Both tags record the “event” of the two wearers meeting each other. Thus an “event” is triggered in the first wearer's tag, shown at step 20. However, this event may or may not be one that is accorded points by the meeting sponsor or organizer.

In step 22, data about the event, in this example, “meeting another tag wearer,” is passed to a code module in the first wearer's tag. The data that is passed includes the type of event (meeting another tag wearer) as well as information about the other tag wearer. The tag then goes through a list of goal types one at a time. In step 24, the current goal is set to the first goal on a list of goals. In step 26, a test is carried out to determine if the current goal is the correct type. Since the example is a “meeting another tag wearer” type of goal, this step 26 will determine if the “current goal” is a “meeting another tag wearer” goal. If not, the procedure skips to step 36 to look for the next goal type in the list.

If the current goal type is the correct type, then the method passes to step 28 where a test is carried out to determine whether the current goal is satisfied by the received data. For example, where Reed talked to Sally, talking to Sally may or may not have been credited any points by the meeting organizer. Therefore step 28 would return a “no” if no points were credited, and the method is passed to step 36 to look for more goal types. However, if meeting Sally was awarded points (and it was because her tag told Reed that she was the bearer of points because her tag displayed a bag with a dollar sign), then the test in step 28 is satisfied, and the method goes on to step 30.

In step 30, a test is carried out to determine if the event being evaluated is a duplicate event. For example, if Reed already had met Sally earlier and was thus already accorded points in his tag, step 30 would fail the “no duplicates” test and pass on to step 36 to look for more goal types. However, if this was the first time Reed had met Sally, the “no duplicates” test in step 30 would be passed, and the method goes on to step 32, where award points are given for meeting Sally, and they are recorded in Reed's tag. The award points are also recorded in step 34 in a current goal buffer in Reed's tag for use in the duplicate detection step 30. When duplicates are checked in this step 30, if the event was a “meeting customer” type event, the method will check (1) if that customer had been met before by the tag wearer (eliminating the second meeting as a “duplicate,”) and (2) if there is a limit on the number of available customer meeting points (for example, three). The event would be eliminated in this step if the tag wearer already had met the maximum three customers. In either case (1) or case (2), no points would be awarded.

Next, the method passes to step 36 to determine if there are more goals in the goals list contained in Reed's tag that might match the event (the event being meeting Sally). It is possible, for example, that Reed's meeting Sally could satisfy multiple goals. There could be a goal for meeting someone with Sally's particular knowledge, and another goal for meeting a predetermined number of executives, of which Sally is one.

Next the method passes to step 38 to check the next goal in the list on Reed's tag. The method, in this manner, cycles through all goals listed in Reed's tag, which may include goals of meeting people, survey completion goals, meeting attendance goals, quiz completion goals, and any other goal types set by the meeting organizer. If the event was not of the type that satisfied a goal listed in Reed's tag, that goal would be eliminated in step 26 as the wrong type. Once all the goals have been checked, the method in step 40 stops.

When a session attendance event passed to the code module, the flow chart of which is shown in FIG. 4, the tag will go through each goal on its list of goals contained in the tag to see if the session attendance event matches the goal type of each goal on the list of goals. Goals in the list that are a different type (not session attendance) will be skipped over. When a session attendance goal is found on the list, the method may check for the time period that the session occurred to be certain that the tag wearer did not already get credit for attending a different session during the same time period. As was described in the above-referenced Patent Application, the tags keep track of time and have this data available for computations. This check will be carried out in step 30, where any session attended during a session time slot will be considered a duplicate of another session attended during the same time slot. Typically, organizers do not want attendees roaming from session to session in an attempt to get points for each of them. Similarly in the case of a “survey completion” or “quiz” event, the method in step 30 will check to be sure that this same survey or quiz had not been completed earlier.

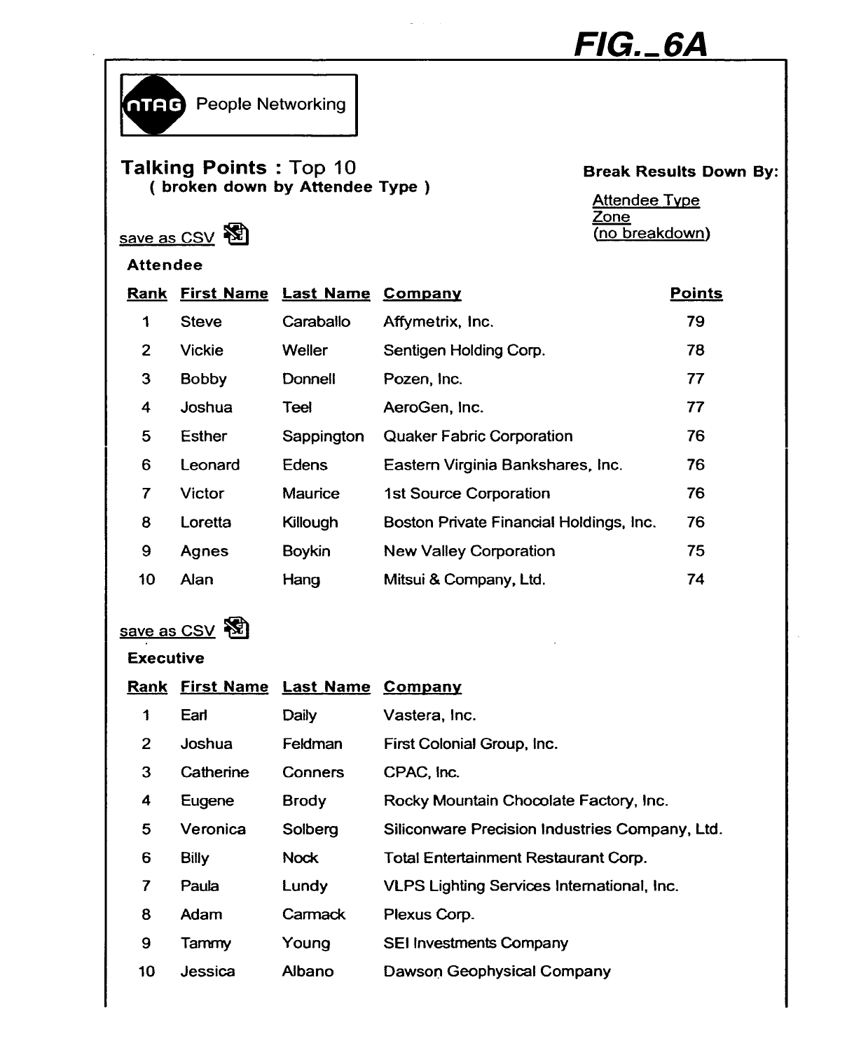

At the end of the meeting, or at intervals during the meeting, data is retrieved from the tags from a wireless transceiver, such as an RFID reader. This will provide to a database on a central server all the events that were triggered on the attendee's tag, as discussed above. The cumulative results can be displayed on a screen in a form such as that shown in FIG. 5 which shows a listing of the top 10 point winners at an event. This information can be gathered during the event, when attendees pass by readers, or continuously if the tags transmit wirelessly all the time, for example, using WiMax or WiFi transmissions. It can also be gathered after the tags are collected at the end of the event, when the tags can easily be read in a number of ways including a wired connection to the server computer either directly or through a LAN, an infrared transmission, or a wireless transmission.

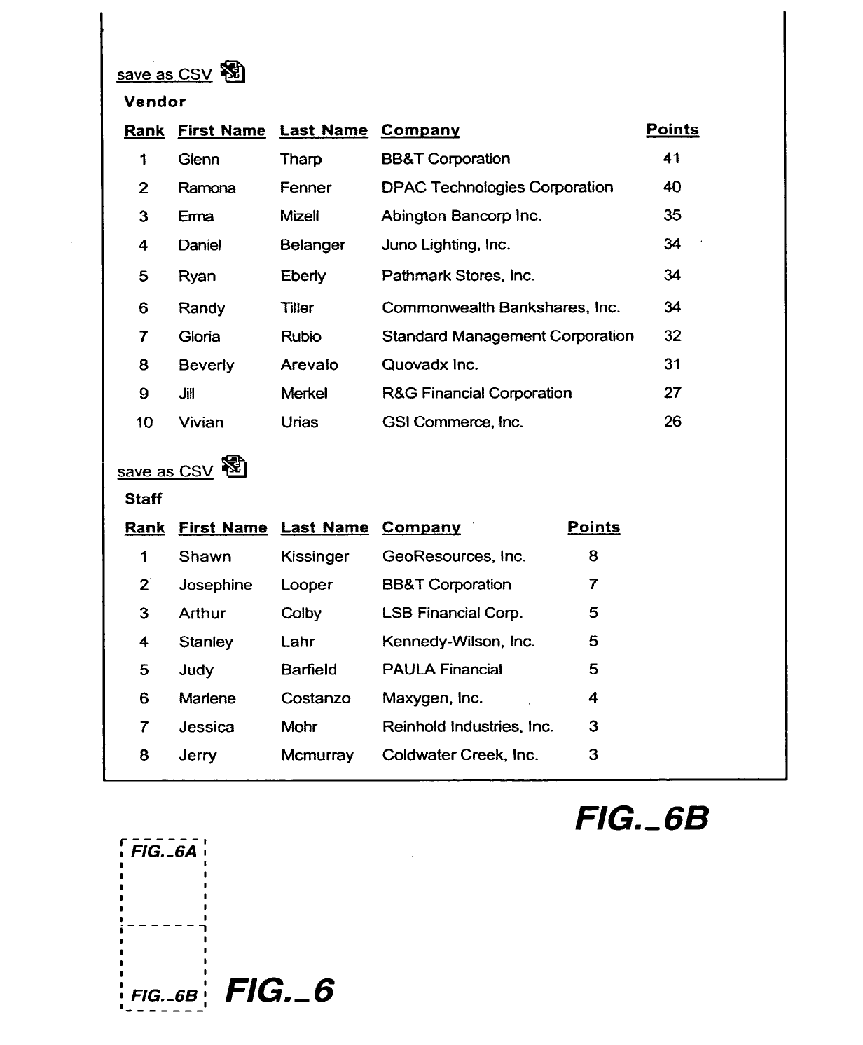

FIGS. 6, 6A and 6B show the top 10 point winners in each category of attendee, such as Executive, Vendor, and Staff. At the discretion of the event organizer, the number of points awarded for meeting staff people may be fewer than those awarded for meeting executives, customers, or even key vendors, which categories are often deemed more desirable contacts. The same discretion applies to attendance at sessions. Some sessions may be deemed by the organizer to be more important, and he or she may thus award more points for attendance at those sessions. Similarly, surveys or quizzes can vary in importance to the organizer, and thus bear different point awards.

Other things may be deemed of overriding importance. For example, no points may be awarded to anyone who does not return his or her tag at the end of the session. Furthermore, points may be awarded for meeting goals only at certain times. For example, more points may be awarded for meeting a particular person on the first day of the session, as opposed to meeting that same person on subsequent days. Since the tags keep track of time, it is easy to include a time factor when calculating an award.

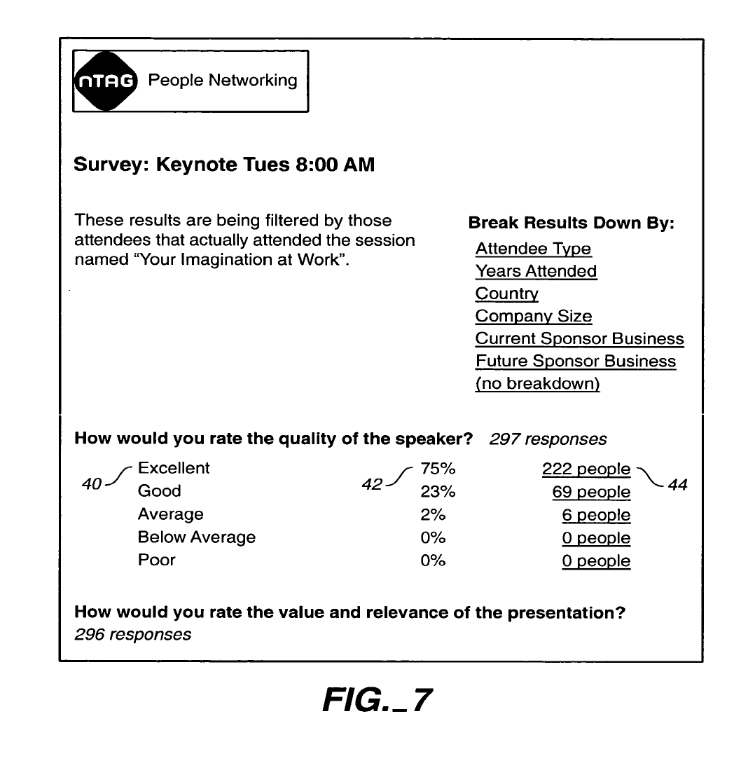

In FIG. 7, survey data is displayed from survey data entered by each meeting attendee into his or her tag. At column 40 in FIG. 7, a list of possible ratings is shown. In column 42, the percent of those completing the survey who ranked the speaker with the indicated ranking, such as excellent, good, average, below average, or poor (shown in column 40) is shown. 75% of the attendees (which in this case was 222 people, as shown in column 44) ranked the speaker “excellent.” 69 people, or 23%, ranked the speaker as “good.”

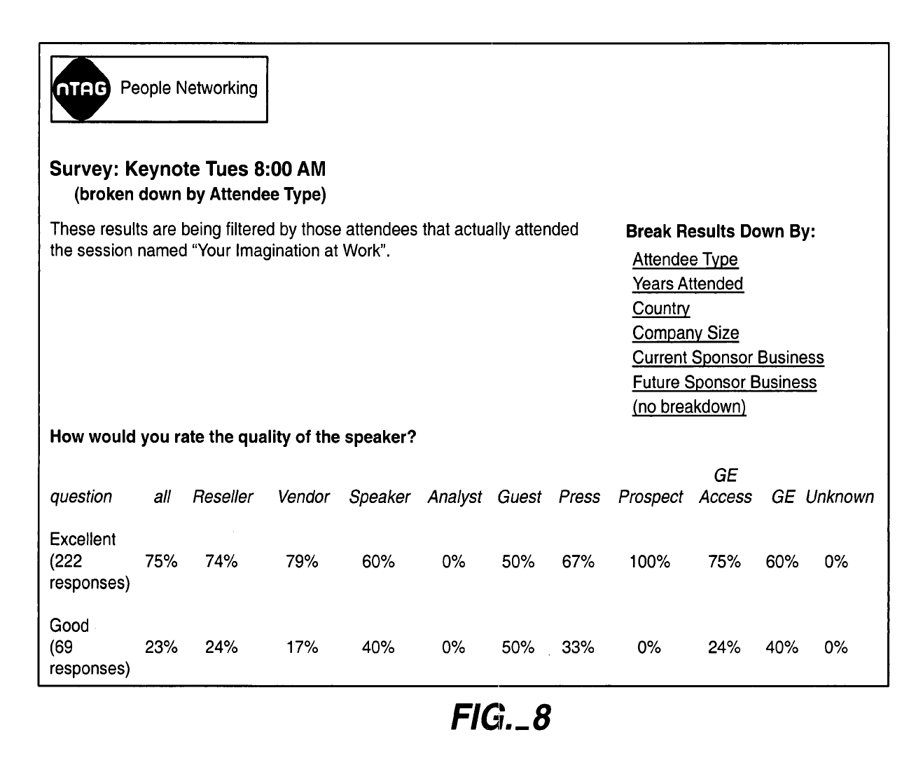

If desired, as shown in FIG. 8, these ratings can be broken down by the type of attendee completing the survey. This “type” indication is stored in each individual's tag. For example, attendee types can include resellers, vendors, speakers, analysts, guests, press, prospects, etc. In FIG. 8, it may be interesting to the event organizer, for example, that the press ranked the speaker lower than did resellers.

Furthermore, goals can be limited to certain classes of tag wearers. For example, if your tag indicates you are a salesman and a particular goal is only awarded to salesmen (and not to staff, for example), the goal awarding process established by the event organizer, discussed above, will determine the classification of the tag wearer (from data in his or her tag) in awarding the points and only award them to members of that class. Since attendees may be classified as to “type” (staff, customer, press, etc.), different behaviors may be scored differently for various types of attendees. For example, it may be valuable to the organizer that a customer fill in a particular survey or take a particular quiz, but a member of the press doing so may have no value. Hence points, in that case, would only be awarded to customers.

Events can also be cumulated. For example, a certain number of points may be awarded for meeting a speaker in person, and an additional number for attending the session where the speaker spoke. If desired, bonus points may be awarded in case an attendee did both. And, for example, even more points may be awarded as a bonus if the attendee spoke to the speaker at the session as opposed to other times during the meeting.

If desired, the method of the invention can generate a “performance report” on an attendee. Such a report can, for example, show a listing of the sessions attended, the people the attendee met (including qualifications of these people as well as their contact data which can be sent from tag to tag as discussed in the above-referenced Patent Application), surveys or quizzes completed, and so on. It can also show individual or cumulative times spent at sessions, at booths, schmoozing, etc.

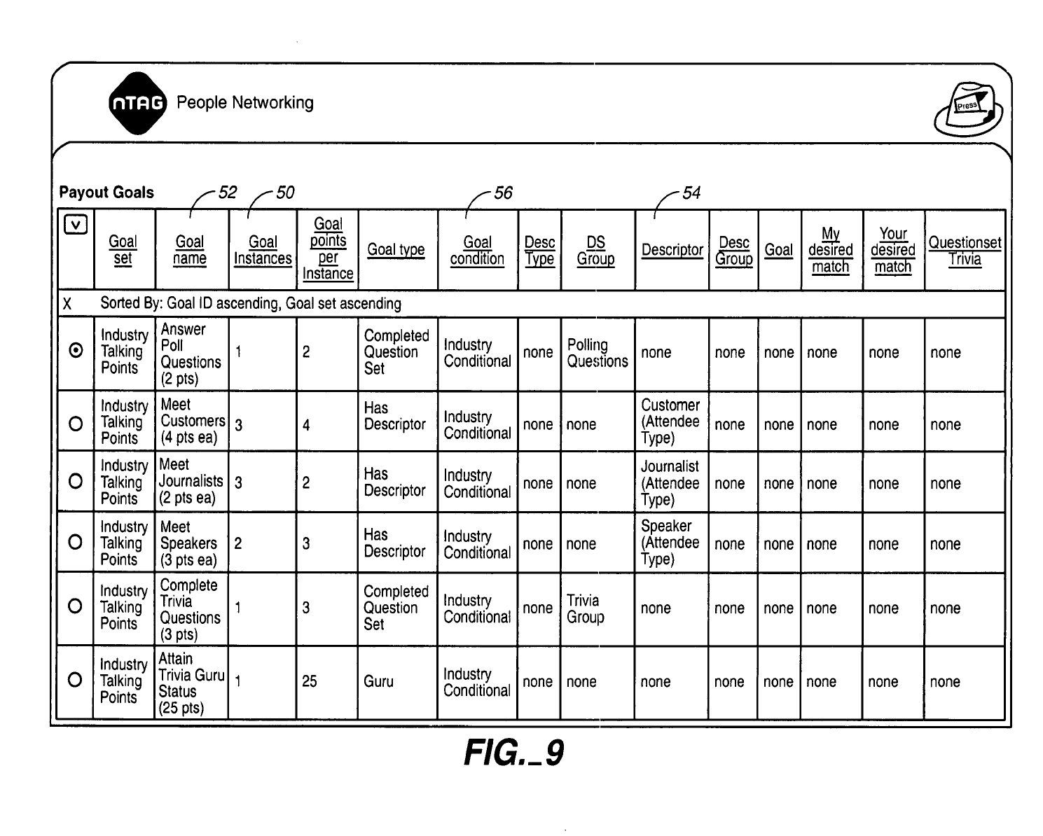

FIG. 9 shows a table used by the event organizer or sponsor in setting goals for the meeting. As shown in the third column 50, some goals may have more than one instance. For example, it is possible to meet more than one customer, but the organizer may want to limit the total number of points awarded for meeting customers. In this case, the maximum number was limited to three customers. Since each customer is worth four points, it would be possible for the tag wearer to earn twelve points by meeting three different customers.

The other goals shown in column 52 of FIG. 9 are self-explanatory. The first goal listed requires answering poll questions. The last two goals in column 52 require completing the answers to trivia questions and answering either a high number of trivia questions (or a high percentage of the most difficult ones) so as to be awarded 25 bonus points as a “trivia guru.” In column 54, a descriptor may be assigned to an attendee, such as “customer,” “journalist,” or “speaker.” In column 56, conditions may be assigned to a goal, such as the goal being required to be reached on a specific day, as discussed earlier. Alternatively, the persons that the tag wearer must meet to win points may be only of a certain industry type, such as biotechnology or nanotechnology. If the wearer meets people from a different industry type, no points will be awarded.

An example of goal types are listed in Table I, below.

Table I
160 Possible points

| | |
|---|---|
| (0/10) | Meet people from a different geography (1 point for each of ten people) |
| (0/10) | Meet people from Asia (5 points for each of two people) |
| (0/5) | Meet people with the same research interest (maximum 5 at 1 point each) |
| (0/40) | Meet top executives (maximum 4 at 10 points each) |
| (0/20) | Visit Platinum Partner Exhibitors (maximum 4 at 5 points each) |
| (0/20) | Visit product demonstrations (maximum 2 at 10 points each) |
| (0/20) | Attend keynote sessions (maximum 5 at 4 points each) |
| (0/15) | Attend closing session (15 points) (a popular one to prevent attendees leaving early) |
| (0/20) | Answer keynote session survey (20 points) |
| (0/20) | Answer keynote session quiz with a score of 80% or higher (30 points) |

The invention is not limited to the preferred embodiment described above, but only as set forth in the claims which follow.

We claim:

1. A method comprising:
setting goals for kinds of actions to be engaged in by people with respect to facilities that are available to them,
at portable electronic devices carried by respective people, displaying information associated with possible actions of the people with respect to the facilities available to them,
receiving at the portable electronic devices responses by the people to the information displayed to them, the responses indicating that the people have engaged in the actions,
based on the responses, logging the occurrences of at least some of the actions that are of kinds for which the goals have been set, while refraining from logging the occurrences of at least some of the actions that are of kinds for which the goals have been set, and
providing recognition of people having reached the goals based on logging of actions of the kinds for which the goals have been set.

2. The method of claim 1 in which the actions also comprise two different portable electronic devices of two different people communicating with each other.

3. The method of claim 1 in which the actions comprise presence at location.

4. The method of claim 3 in which one of the goals comprises a combination of the responses and presences at locations.

5. The method of claim 2 in which the goals are based in part on the identities of the people.

6. The method of claim 1 further comprising:
(a) wirelessly transmitting a request for input to the first computing device from a transmitter/receiver having a location,
(b) receiving the first attendee's response to the request from the first computing device through the transmitter/receiver; and
(c) transmitting the received response through the transmitter/receiver to a central location along with information identifying the location of the transmitter/receiver.

7. The method of claim 6 also comprising transmitting the time at which the first attendee's response was input to the first computing device through the transmitter/receiver to the central location.

8. A method comprising:
receiving at a computer, from a computing device worn by an attendee at a meeting, indicia for actions of different types in which the attendee has engaged, as determined by the computing device, in which respective values are associated with the different types of actions; each of the indicia being maintained at the computing device for each detected action of the attendee excluding the action that has occurred for a number of times exceeding a predetermined value; the actions including feedback provided by the attendee through the computing device and attending sessions at the meeting; the indicia including receipt of feedback provided by the attendee through the computing device about activities at the meeting;
generating at a computer an aggregate performance score that is formed by weighting the indicia for actions of different types using the respective values; and
reporting the aggregate performance score to a user at a computer.

9. The method of claim 1 comprising displaying at the portable electronic devices, the information about the logging of the occurrences.

10. The method of claim 1 also comprising displaying at the portable electronic devices, the reaching of the goals by respective people.

11. The method of claim 1 in which the actions include one or more of people communicating with one another, being in a location at a determined time, providing the responses, attending sessions, and providing feedback.

12. A method of encouraging attendees wearing a computing device at a meeting to engage in different types of desired behaviors, the method comprising:
(a) for each action of each of the attendees,
disregarding the action if it has occurred for a number of times exceeding a predetermined value; and
maintaining an indicia on the device for the action if it is undisregarded;
(b) assigning, by computer, respective action values to different types of actions;
(c) deriving aggregate performance scores by weighting the indicia for actions of different types using the respective action value, the aggregate performance score scores being indicative of the attendees' behavior at the meeting, the aggregate performance scores being based on predetermined desired performance criteria;
(d) displaying in a way that is publicly accessible, the aggregate performance scores for the attendees; and
(e) providing a reward to attendees on the basis of the aggregate performance scores.

13. The method of claim 12 in which the deriving of the aggregate performance scores for the attendees is based in part on groups to which the attendees belong.

14. The method of claim 12 also comprising comparing the aggregate performance scores for two or more of the attendees, in which the aggregate performance scores are based in part on a group to which the two or more attendees belong.

15. The method of claim 8 in which the indicia indicate that the attendee met specific individuals.

16. A method comprising:
for actions of different types by a first attendee at a meeting, the different types of actions being associated with respective action values, detecting the actions at a first computing device worn by the first attendee, the detecting of the actions including all of:
the first computing device communicating with a second computing device worn by a second attendee,
receiving input from the first attendee, and
determining a location of the first attendee at a predetermined time;
for each detected action,
disregarding the action that has occurred for a number of times exceeding a predetermined value; and
maintaining an indicia on the device for the undisregarded action;
deriving from the indicia of actions of different types, an aggregate performance score of the first attendee at the meeting by weighting the indicia for actions of different types using the respective action values, in which the actions of the first attendee include one or more of entering information into the first computing device, being at a location, and communicating with the second attendee; and
displaying the aggregate performance score on a display of the first computing device worn by the first attendee.

17. The method of claim 1 in which the goal comprises a number of times one of the people engages in actions of one of the kinds.

18. The method of claim 1 in which the actions comprise presences at facilities.

19. The method of claim 1 in which the facilities comprise sessions at an event.

20. The method of claim 1 in which the displayed information comprises questions about the facilities.

21. The method of claim 1 in which the refraining from logging occurrences comprises inferring that the responses do not indicate that the people have engaged in actions of the kinds for which the goals have been set.
